(19) United States
(12) Patent Application Publication
(10) Pub. No.: US 2026/0093543 A1
(43) Pub. Date: Apr. 2, 2026

(54) DATA PROCESSING METHOD, ELECTRONIC DEVICE AND STORAGE MEDIUM

(71) Applicant: Lenovo (Beijing) Limited, Beijing (CN)

(72) Inventors: Xiaolong ZHANG, Beijing (CN); Zhiyi CAI, Beijing (CN); Maoyuan WU, Beijing (CN); Jianhui CAI, Beijing (CN)

(21) Appl. No.: 19/340,868

(22) Filed: Sep. 26, 2025

(30) Foreign Application Priority Data
Sep. 30, 2024 (CN) 202411391910.7

(51) Int. Cl. G06F 9/50

(52) U.S. Cl. CPC G06F 9/5027

(57) ABSTRACT

A data processing method includes obtaining target files of target function modules and parsing the target files to obtain at least one target capability of each target function module and a calling service configured to invoke the at least one target capability. Each target capability includes a capability name and a capability description, and a capability description is expressed in natural language. The calling service of each target capability includes a first service that provides input parameters for processing by a target function module of the target function modules and a second service that obtains output results from the target function module.

### CROSS-REFERENCE TO RELATED APPLICATION

This application claims priority of Chinese Patent Application No. 2024113919107, filed on Sep. 30, 2024, the entire contents of which are hereby incorporated by reference.

### FIELD OF THE DISCLOSURE

The present disclosure generally relates to the field of computer technology and, more particularly, relates to a data processing method and an electronic device.

### BACKGROUND

When performing a task in an electronic device, corresponding function modules in the electronic device are typically invoked. Therefore, it is necessary to determine capabilities of each function module in the electronic device in advance.

However, when collecting capabilities of function modules in an electronic device, a user needs to manually configure capabilities of each function module in the electronic device and define a calling method and parameters for each function module. Therefore, the operation of the electronic device is highly complex.

### BRIEF SUMMARY OF THE DISCLOSURE

One aspect of the present disclosure provides a data processing method. The data processing method includes obtaining target files of target function modules and parsing the target files to obtain at least one target capability of each target function module and a calling service configured to invoke the at least one target capability. Each target capability includes a capability name and a capability description, and a capability description is expressed in natural language. The calling service of each target capability includes a first service that provides input parameters for processing by a target function module of the target function modules and a second service that obtains output results from the target function module.

Another aspect of the present disclosure provides an electronic device. The electronic device includes one or more processors and a memory containing computer program that, when being executed, causes the one or more processors to perform: obtaining target files belonging to target function modules; and parsing the target files to obtain at least one target capability possessed by the target function modules and a calling service that invokes the at least one target capability. Each target capability includes a capability name and a capability description, and the capability description is expressed in natural language. The calling service of each target capability includes a first service that provides input parameters for processing by a target function module of the target function modules and a second service that obtains output results from the target function module.

Another aspect of the present disclosure provides an electronic device. The electronic device includes one or more processors and a capability management module running on a corresponding processor of the one or more processors and configured to cause the corresponding processor to obtain target files, which belong to at least one target function module, and parse the target files to obtain at least one target capability of the at least one target function module and a calling service that invokes the at least one target capability. Each target capability includes a capability name and a capability description, and the capability description is expressed in natural language. The calling service of each target capability includes a first service that provides input parameters for processing by a target function module of the at least one target function module and a second service that obtains output results from the target function module.

Other aspects of the present disclosure can be understood by a person skilled in the art in light of the description, the claims, and accompanying drawings of the present disclosure.

### BRIEF DESCRIPTION OF THE DRAWINGS

To more clearly illustrate technical solutions of the embodiments of the present disclosure, the accompanying drawings used to describe the embodiments are briefly introduced below. It should be understood that the accompanying drawings described herein represent only some embodiments of the present disclosure. Other drawings may be derived by a person skilled in the art based on the accompanying drawings without creative efforts.

FIG. 1 illustrates a flowchart of a data processing method consistent with various embodiments of the present disclosure.

FIG. 2 illustrates an exemplary diagram of target function modules arranged in an electronic device consistent with various embodiments of the present disclosure.

FIG. 3 illustrates a partial flowchart of a data processing method consistent with various embodiments of the present disclosure.

FIG. 4 illustrates an exemplary diagram of realizing a capability invocation through an agent service (AS) consistent with various embodiments of the present disclosure.

FIG. 5 illustrates another exemplary diagram of realizing a capability invocation through an AS consistent with various embodiments of the present disclosure.

FIG. 6 illustrates an exemplary diagram of an interconnection between an electronic device and a target device consistent with various embodiments of the present disclosure.

FIG. 7 illustrates an exemplary diagram of a capability description on a target device as obtained by an electronic device consistent with various embodiments of the present disclosure.

FIG. 8 illustrates an exemplary diagram of implementing a capability invocation on an electronic device consistent with various embodiments of the present disclosure.

FIG. 9 illustrates an exemplary diagram of invoking capabilities on a target device by an electronic device consistent with various embodiments of the present disclosure.

FIG. 10 illustrates a schematic diagram of an electronic device consistent with various embodiments of the present disclosure.

FIG. 11 illustrates another schematic diagram of an electronic device consistent with various embodiments of the present disclosure.

FIG. 12 illustrates another schematic diagram of an electronic device consistent with various embodiments of the present disclosure.

FIG. 13 illustrates another schematic diagram of an electronic device consistent with various embodiments of the present disclosure.

FIG. 14 illustrates a schematic diagram of an interconnection between an electronic device and a target device consistent with various embodiments of the present disclosure.

FIG. 15 illustrates another exemplary diagram of a capability description on a target device as obtained by an electronic device consistent with various embodiments of the present disclosure.

FIG. 16 illustrates an exemplary diagram of implementing a capability invocation on an electronic device consistent with various embodiments of the present disclosure.

FIG. 17 illustrates an exemplary diagram of invoking capabilities on a target device by an electronic device consistent with various embodiments of the present disclosure.

FIG. 18 illustrates an exemplary diagram of an application being applicable to mobile phones to implement capability collection and capability invocation in the present disclosure.

FIG. 19 illustrates an interaction sequence diagram for capability collection and capability invocation in scenarios involving mobile phones and laptops in the present disclosure.

### DETAILED DESCRIPTION

The technical solutions in the embodiments of the present disclosure are described below in detail with reference to the accompanying drawings. The embodiments described represent only some rather than all the embodiments of the present disclosure. Based on the embodiments in the present disclosure, all other embodiments derived by a person skilled in the art without creative efforts fall within the protection scope of the present disclosure.

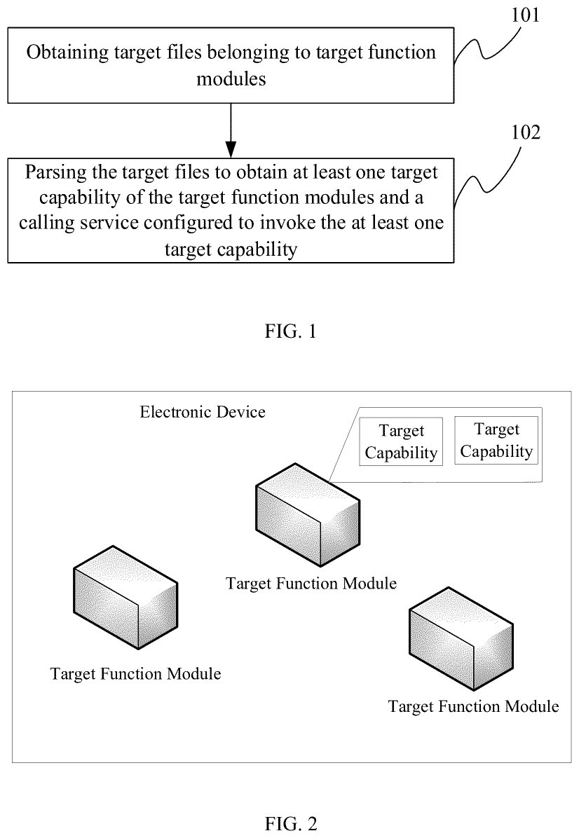

FIG. 1 illustrates a flowchart of a data processing method consistent with various embodiments of the present disclosure. The method can be applied to electronic devices arranged with target function modules and capable of data processing, such as mobile phones, tablets, laptops, or servers. As shown in FIG. 2, one or more target function modules can be arranged in an electronic device, and each target function module can implement one or more corresponding functions, referred to as target capabilities. In one embodiment, the technical solution is primarily used to reduce an operational complexity of collecting capabilities from target modules on the electronic device.

Specifically, the method in the embodiment may include the following steps.

101: obtaining target files belonging to target function modules.

Each target function module includes a target file. The target file may be in an XML format. The target file records at least one target capability possessed by the target function module and a calling service configured to call the at least one target capability.

In a specific implementation, the target files may be provided by a developer of the target function modules. When a target function module is developed or upgraded, the developer adds a target file to the target function module, so that the target file of each target function module can be obtained on the electronic device.

For example, when upgrading a social application arranged on the electronic device, an upgraded package may be downloaded from a server of an application provider. The upgrade package includes a target file of an interactive application. The target file records at least one target capability of the social application and a calling service configured to invoke the at least one target capability.

For another example, when installing a map application on the electronic device, an installation package may be downloaded from a server of an application provider. The installation package includes a target file of the map application. The target file records at least one target capability of the map application and a calling service configured to invoke the at least one target capability.

In one embodiment, each target file of a target function module can be scanned by a package manager in an operating system, such as PackageManager.

102: parsing the target files to obtain at least one target capability of the target function modules and a calling service configured to invoke the at least one target capability.

Each target capability includes a capability name and a capability description expressed in natural language. Furthermore, a calling service of each target capability includes a first service configured to provide input parameters for processing by a target function module, and a second service configured to obtain output results from the target function module. The capability name is used to uniquely identify a corresponding target capability, and the capability description, expressed in natural language, specifies a function implemented by the corresponding target capability.

Taking a specific target function module as an example, the target capabilities of the target function module related to artificial intelligence (AI) may be independently declared in a target file, such as an XML file. The following code snippet is provided as an example:

```
<?XML version=“1.0” encoding=“utf-8”?>
<capabilitys>
  <capability>// Declare a target capability
    <method
      name=“catchMeUp”// Name of the target capability
      description=“summarize for notifications”// Capability description
of the target capability
      sourceName=“phone” />
    <returnParameters>
      <parameter
        name=“response”
        description=“summary result” />
    </returnParameters>
  </capability>
  <capability>// Declare a target capability
    <method
      name=“imageGenerate”// Name of the target capability
      description=“generate image for text”// Capability description of
      the target capability
      sourceName=“phone” />
    <parameters>
      <parameter
        name=“imageDesc”
        description=“To generate the picture, describe the details of the
        picture in detail”
        required=“true” />
    </parameters>
    <returnParameters>
      <parameter
        name=“image”
        description=“byte array for image” />
    </returnParameters>
  </capability>
</capabilitys>
```

In the above example, two AI capabilities are declared in a “description” field as capability descriptions: (1) summarize for notifications; and (2) generate image for text. As shown in the following code snippet, a calling service configured to invoke a corresponding target capability may also be declared in an XML file:

```
class ExportCapabilityService : MotoAiCapabilityService( ) {
  override fun invokeAiCapability(bundle: Bundle, callback:
  IMotoAiCapabilityCallback) {
    val method = bundle.getString(“methodName”)
    logD {
    “ExportAbilityService-->invokeAiCapability( ),method=$method” }
    when (method) {
      “catchMeUp” -> {
        CatchMeUpHandler(this, bundle, callback).execute( )
      }
      “imageGenerate” -> {
        ImageGeneratorHandler(this, bundle, callback).execute( )
      }
    }
  }
}
```

A method call “CatchMeUpHandler(this, bundle, callback).execute( )” serves to invoke a target capability “catchMeUp”. The “bundle” represents the first service configured to provide input parameters for processing by the target function module. That is, the first service provides the input parameters to the target function module to facilitate processing by the target function module. The “callback” represents the second service configured to obtain output results from the target function module. In other words, the target function module processes the input parameters to implement the target capability “catchMeUp”, thereby generating the output results.

Therefore, the XML file of the target function module is obtained in the electronic device, and the XML file is parsed to obtain the first service and the second service among the target capabilities of the target function module, including the capability name, the capability description, and the calling service for calling each target capability.

Specifically, in the electronic device, the parsed target capabilities can be saved in a capability list. For example, as shown in the following code:

```
private void scanAllAiCapabilities( ) {// Scan XML file
    List<ResolveInfo> services;// Define the capability list that holds the target capability
    Intent intent = new Intent(AI_ACTION);
    services = mPkgManager.queryIntentServices(intent,
PackageManager.GET_META_DATA// Scan XML files through a package manager
| PackageManager.MATCH_DISABLED_UNTIL_USED_COMPONENTS);
    for (ResolveInfo service : services) {// Traverse the installation package of the target
function module
        ServiceInfo serviceInfo = service.serviceInfo;
        Log.d(TAG, “ pkg:” + serviceInfo.packageName
    + “ resid:” + serviceInfo.metaData.getInt(“android.moto_ai_capability”));
        try {// Parse XML
Resources resources =
mPkgManager.getResourcesForApplication(serviceInfo.packageName);
          XMLResourceParser XMLResourceParser =
resources.getXML(serviceInfo.metaData.getInt(“android.moto_ai_capability”));// The
parsing results of XML are placed in “resources”
          parse XML(XMLResourceParser, serviceInfo.packageName);
      } catch (PackageManager.NameNotFoundException e) {// Handle parsing errors
          Log.e(TAG, “errMsg:”, e);
        }
    }
  }
```

On the electronic device, the XML files can be scanned through a package manager such as PackageManager, and the XML files can be parsed to obtain target capabilities of each target function module on the electronic device and the calling service configured to call the target capabilities.

It should be noted that, in one embodiment, the data processing method may be implemented through a capability management module arranged on the electronic device, including as an agent service (AS) module.

In a specific implementation, the target function module is arranged with function sub-modules corresponding to each target capability the target function module possesses, where each function sub-module is configured to achieve the corresponding target capability. Based on the above, the first service provides input parameters to one of the function sub-modules in the target function module, so that the function sub-modules can process the input parameters to achieve the target capability corresponding to the function sub-module, thereby generating output results corresponding to the target capabilities. The output results corresponding to the target capabilities are retrieved from the function sub-module in the target function module through the second service.

It can be seen from the above technical solutions that, in the data processing method provided by the embodiment, by parsing the target files of the target function modules, the target capabilities of the target function modules and the calling services configured to call the target capabilities can be obtained. Accordingly, when the target capabilities need to be invoked, the target capabilities can be utilized through the corresponding calling services. In the above process, a user is not required to manually configure the capabilities of each function module on the electronic device, nor to explicitly define the calling method and parameters for each function module. As a result, the operational complexity of capability invocation on the electronic device may be reduced, thereby improving the user experience.

In one embodiment, a tag corresponding to the target function module can also be established. The tag represents a correspondence relationship between the target function module, each target capability of the target function module, and the call service configured to invoke a corresponding target capability.

Therefore, by recording the correspondence relationship between the target function module, the target capability, and the calling service in the electronic device, it can be determined that the calling service parsed from the target file corresponds to the associated target function module.

For example, after parsing an XML file of a social application, a tag for the social application is established, and the tag represents a correspondence relationship among the social application, the parsed target capability of the social application and the calling service. Based on the correspondence relationship, the target function module associated with the target capability can be identified. Additionally, the capability description of the target capability may also characterize a corresponding target function module, and the calling service corresponding to the target capability can be located.

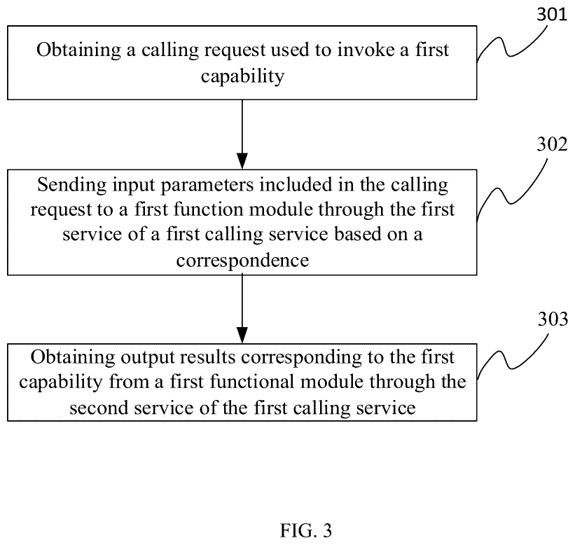

Based on the above implementation, additional processing steps may be performed in one embodiment, as illustrated in FIG. 3.

301: obtaining a calling request used to invoke a first capability.

The calling request includes input parameters. It should be noted that the first ability refers to a target capability needed to perform a specific task, such as a timing capability, a Venn diagram generation capability, or similar.

302: sending input parameters in the calling request to a first function module through a first service of a first calling service based on a correspondence relationship.

303: obtaining output results corresponding to the first capability from the first function module through a second service of the first calling service.

The first function module is a target function module to which the first capability belongs. In the embodiment, tags of all target function modules may be used to search for the target function module to which the first capability belongs, and to identify the calling service configured to invoke the first capability, including the first function module, the first service, and the second service. Accordingly, in the embodiment, the input parameters of the calling request can be sent to the first function module through the first service, so that the first function module processes the input parameters to implement the first capability, thereby generating a corresponding output result. The output results obtained by the first function module can be retrieved through the second service.

Based on the implementation scheme described above, the calling request may be generated by processing user needs in conjunction with the capability descriptions obtained from a target application. The output results corresponding to the first capability are used as feedback information for the target application to fulfill the user needs.

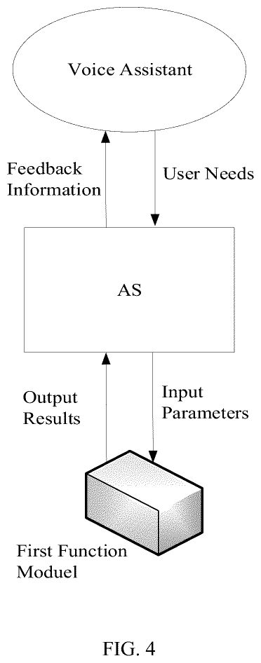

For example, as shown in FIG. 4, the target application can be an artificial intelligence assistant, such as a voice assistant on a mobile phone or the like. The voice assistant can receive input data such as texts or voices that represent user needs. Based on the input data, in one embodiment, the AS that implements the data processing method processes input data along with the capability description of each target capability to generate a calling request, which represents a need to invoke the first capability, and includes input parameters to be transmitted to a function sub-module in the first function module corresponding to the first capability. Accordingly, the AS determines the first service and the second service in the calling service that invoke the first capability based on a correspondence relationship represented by a tag. The AS uses the first service to transmit the input parameters in the calling request to the function sub-module in the first function module corresponding to the first capability. The function sub-module processes the input parameters to generate output result, thereby realizing the first capability. The output results are retrieved from the function sub-module corresponding to the first capability in the first function module through the second service. In the embodiment, the AS provides the obtained output results to the voice assistant as feedback information addressing the user needs, and the voice assistant presents the feedback information to the user through voice playback or text output.

In one implementation, one embodiment may utilize an intelligent engine configured to process user needs along with each capability description obtained from the target application to generate a calling request. The intelligent engine includes the capability descriptions, which may be provided by the embodiment.

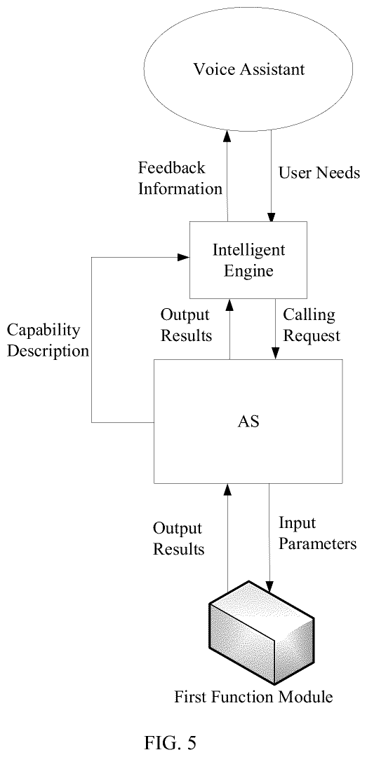

For example, as shown in FIG. 5, in one embodiment, the AS that implements the data processing method transmits the collected capability description of each target capability to the intelligent engine. Accordingly, the intelligent engine processes the user needs and the received capability description, obtained through the voice assistant, to determine the target capability required to satisfy the user needs, namely, the first capability.

Furthermore, in one embodiment, based on the intelligent engine, the output results corresponding to the first capability can be provided to the target application as feedback information addressing the user needs.

For example, as shown in FIG. 5, once a calling request is generated by the intelligent engine, the calling request indicates a need to invoke the first capability and includes input parameters to be transmitted to the function sub-module corresponding to the first capability. In one embodiment, the AS that implements the data processing method can determine the first service and the second service in the calling service used to invoke the first capability based on a correspondence relationship represented by a tag. The AS transmits the input parameters included in the calling request to the function sub-module within the first function module corresponding to the first capability through the first service. The function sub-module corresponding to the first capability processes the input parameters to generate an output result, thereby realizing the first capability. The output results are retrieved from the function sub-module corresponding to the first capability in the first function module through the second service. The AS sends the output results to the intelligent engine, which provides the output results as feedback information addressing the user needs to the voice assistant, which presents the feedback information to a user through voice playback or text output.

In one embodiment, the intelligent engine may include an artificial intelligence core (AI Core) arranged within an electronic device, and the AI Core can understand natural language intent. Alternatively, the intelligent engine may include both the AI Core and a large language model (LLM). The LLM may be arranged on the electronic device, a separate device, or in a cloud environment. In the embodiment, the calling request can be generated based on the AI Core. If the AI Core cannot process the user needs and capability description, that is, the AI Core cannot generate the calling request, the calling request may instead be generated based on the LLM.

Large language model (LLM) may be a machine learning model, based on deep neural network architectures such as the Transformer, that has been trained on large-scale corpora of natural language data. An LLM contains a very high number of parameters, e.g., in the order of billions or more, which enables LLM to capture statistical patterns, semantic relationships, and/or contextual dependencies in human language. The LLM can perform tasks including, but not limited to: natural language understanding (e.g., intent recognition, information extraction), natural language generation (e.g., text completion, summarization, dialogue response), reasoning and decision support, code generation, and multi-modal integration (in some cases). LLMs may operate by processing input sequences of tokens (text units) and predicting subsequent tokens in context, which allows them to generate coherent, contextually appropriate text. The large parameter size and training data scale distinguish LLMs from conventional language models, providing broader generalization and adaptability across domains without task-specific training.

In one embodiment, the electronic device may be interconnected with a target device. Based on the interconnection, the electronic device can collect target capabilities associated with each third function module arranged on the target device. Each third function module includes at least one target capability and a corresponding calling service for invoking the at least one target capability. A target capability of the at least one target capability includes a capability name and a capability description. Similarly, the target device can also collect the target capabilities of each target function module arranged on the electronic device.

Specifically, the target function modules in the electronic device include a second function module arranged on the electronic device. The second function module can establish a connection channel between the electronic device and the target device. For example, the second function module may be a smart connect application (or smart connect application in some embodiments) configured to enable device interconnection and establish the connection channel between the electronic device and the target device.

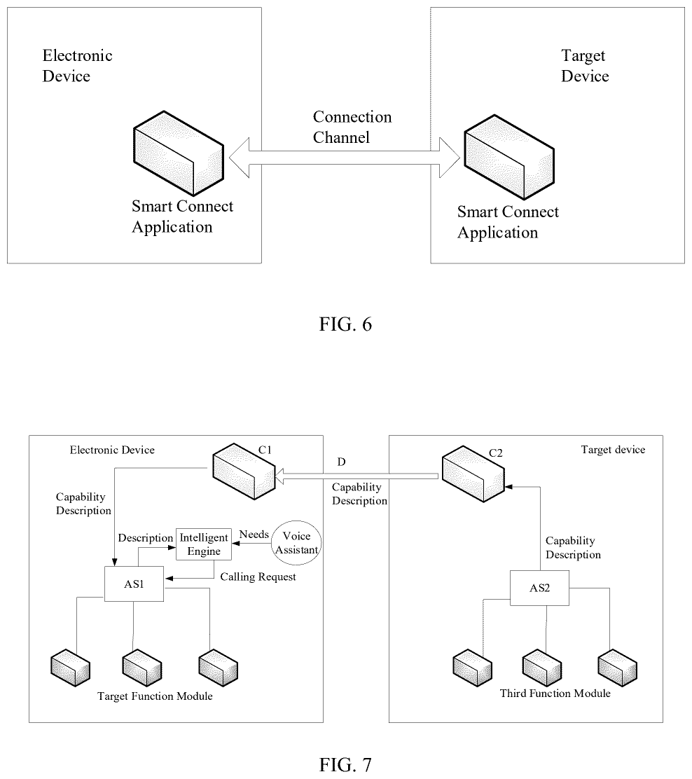

For example, as shown in FIG. 6, both the electronic device and the target device are arranged with smart connect application. The smart connect application is an upper-layer application of an operating system and can establish the connection channel between the electronic device and the target device.

Based on the above, in one embodiment, the intelligent engine on the electronic device can also obtain the capability description of at least one target capability of the third function modules arranged on the target device from the capability management module AS that implements the data processing method. The capability description of the at least one target capability possessed by the third function modules is transmitted from the target device to the AS through the connection channel between the target device and the electronic device.

In one embodiment, in addition to recording at least one target capability of the second target function module and a calling service for invoking the at least one target capability, a target file of the second function module may also record target capabilities of the third function modules arranged on the target device, along with a calling service for invoking the target capabilities of the third function modules. The target capabilities of the third function modules arranged on the target device, along with the corresponding calling services, are recorded in a target file and transmitted by the target device to the second function module through the connection channel established by the second function module. Based on the above, the capability management module AS on the electronic device can obtain the target capabilities and corresponding calling services of the third function modules arranged on the target device by parsing the target file of the second function module. Accordingly, the capability management module AS obtains the capability description of the target capabilities of the third function modules arranged on the target device.

Further, in one embodiment, the capability management module AS that implements the data processing method in the electronic device can transmit a calling request to the target device through the connection channel when the calling request corresponds to the target device. The target device, using the arranged capability management module, calls the first service of the first calling service. The input parameters in the calling request are sent to a third function module corresponding to the first capability and output results corresponding to the first capability are obtained from the third function module through the second service of the first calling service. The output results corresponding to the first capability sent by the target device are received through the connection channel. The capability management module AS in the electronic device that implements the data processing method can provide the output results corresponding to the first capability to the target application as feedback information to the target application based on the intelligent engine, thereby addressing the user needs.

For example, as shown in FIG. 7, a capability management module AS1 is arranged on the electronic device, and a capability management module AS2 is arranged on the target device. Smart connect applications such as C1 and C2 are respectively arranged on both the electronic device and the target device. A connection channel D is established between the smart connect applications C1 and C2. AS2 can collect the target capabilities of each third function module arranged on the target device and the corresponding calling service for calling the target capabilities using the data processing method described above. AS2 transmits the collected capability description of the target capability to the smart connect application C2 on the target device. The smart connect application C2 on the target device transmits the capability description collected by AS2 to the smart connect application C1 on the electronic device through the connection channel D. The smart connect application C1 forwards the capability descriptions received from AS2 to AS1. AS1 sends both the capability description collected by AS1 and the capability description collected by AS2 to the intelligent engine. Therefore, the intelligent engine can process the user needs together with capability descriptions obtained by the voice assistant to determine a target capability required to satisfy the user needs, namely the first capability. Based on the above determination, the intelligent engine generates a calling request and provides the calling request to AS1. Whether the first function module is a target function module arranged on the electronic device or a third function module arranged on the target device can be determined based on capability descriptions of the first capability.

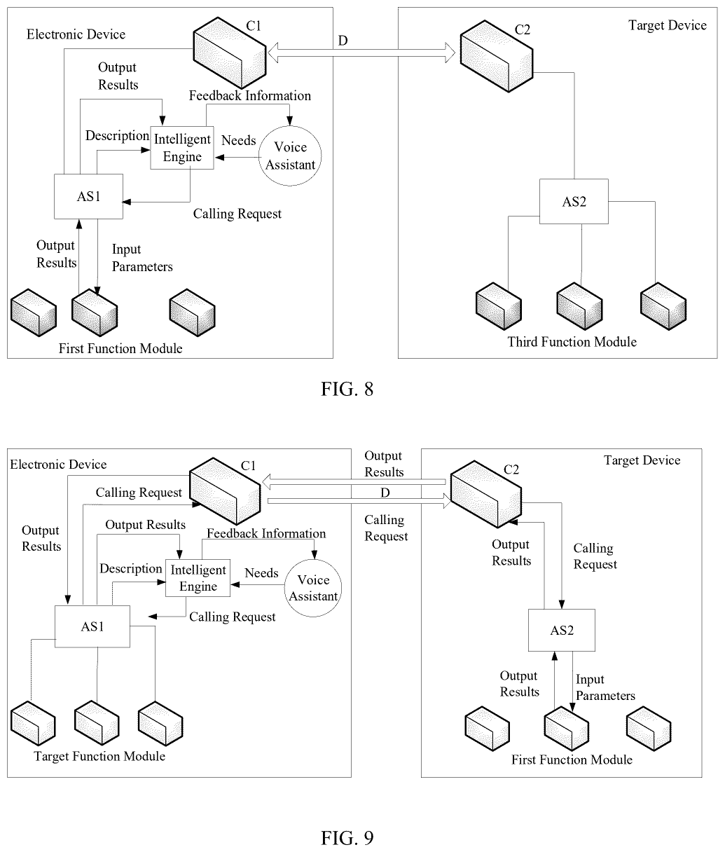

If the first function module is a target function module arranged on the electronic device, the capability management module AS1 can determine the first service and the second service in the calling service for invoking the first capability based on a correspondence on the electronic device. AS1 can use the first service to transmit the input parameters contained in the calling request to the function sub-module corresponding to the first capability within the first function module on the electronic device. The function sub-module corresponding to the first capability processes the input parameters to generate an output result, thereby implementing the first capability. The output results are retrieved from the function sub-module corresponding to the first capability within the first function module through the second service, as illustrated in FIG. 8. In the embodiment, AS1 transmits the obtained output results to the intelligent engine. The intelligent engine then provides the output results as feedback information addressing the user needs to the voice assistant, which presents the feedback information to a user through voice playback or text output.

If the first function module is a third function module arranged on the target device, AS1 may transmit the calling request to the smart connect application C1 on the electronic device. As shown in FIG. 9, the smart connect application C1 on the electronic device forwards the calling request to the smart connect application C2 on the target device through the connection channel D. The smart connect application C2 on the target device delivers the calling request to AS2. AS2 can determine the first service and the second service in the calling service used to invoke the first capability based on a correspondence relationship on the target device. The input parameters in the calling request are provided to the function sub-module corresponding to the first capability in the first function module on the target device through the first service. The function sub-module processes the input parameters to obtain the output result, thereby realizing the first capability. The output results are obtained from the function sub-module corresponding to the first capability in the first function module through the second service. AS2 transmits the obtained output results to the smart connect application C2 on the target device. The smart connect application C2 on the target device transmits the output results to the smart connect application C1 on the electronic device through the connection channel D. The smart connect application C1 on the electronic device sends the output results to AS1. AS1 delivers the output results to the intelligent engine. The intelligent engine provides the output results as feedback information addressing the user needs to the voice assistant, which presents the feedback information to a user through voice playback or text output.

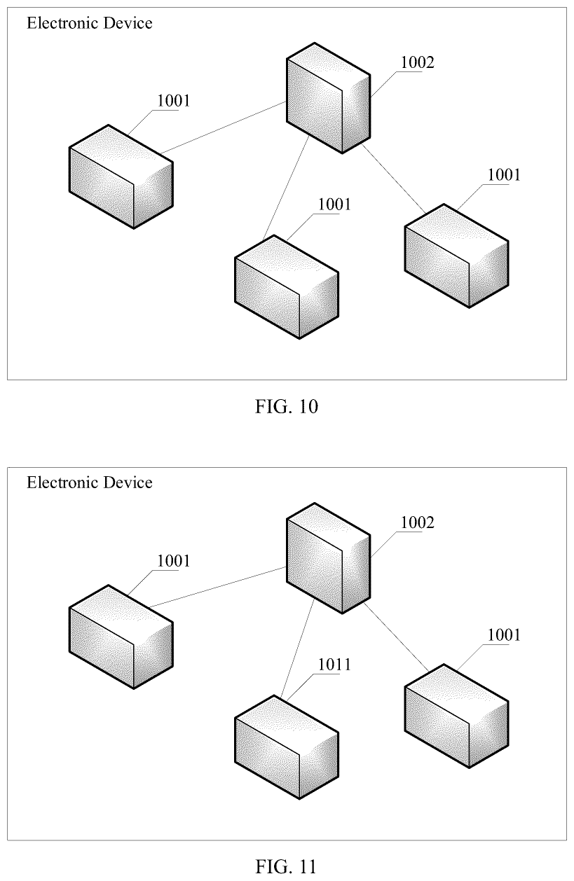

FIG. 10 illustrates a schematic diagram of an electronic device consistent with various embodiments of the present disclosure. The electronic device may include the following components: at least one target function module 1001, where each target function module 1001 possesses at least one target capability and an associated calling service for invoking the target capability; and a capability management module 1002 (e.g., AS), configured to obtain target files of target function modules 1001 and parse the target files to obtain at least one target capability of each target function module 1001 and the calling service that invokes the at least one target capability. Each target capability includes a capability name and a capability description, and a capability description is expressed in natural language. The calling service corresponding to each target capability includes a first service for providing input parameters to be processed by the target function module 1001 and a second service for obtaining the output results from the target function module 1001.

As illustrated by the above technical solution, in the electronic device provided by one embodiment, the capability management module is configured to parse target files of target function modules to obtain corresponding target capabilities and calling services used to invoke the target capabilities. As a result, when the target capabilities need to be invoked, the target capabilities can be accessed directly through respective calling services. The above process eliminates a need for users to manually configure capabilities of each function module on the electronic device or to explicitly define calling methods and input parameters. Consequently, a process of collecting and utilizing capabilities is simplified, thereby enhancing an overall user experience with the electronic device.

In one embodiment, as shown in FIG. 11, a capability management module 1002 is further configured to: obtain a calling request to invoke a first capability, the calling request including input parameters; transmit, based on a correspondence relationship in the capability management module 1002, the input parameters to the first function module 1011 through the first service of the first calling service; and obtain the output results corresponding to the first capability from the first function module through the second service of the first calling service. The capability management module 1002 establishes a tag for the target function module 1001, which represents a correspondence relationship between the target function module 1001, the target capability possessed by the target function module 1001 and the calling service of the target capability.

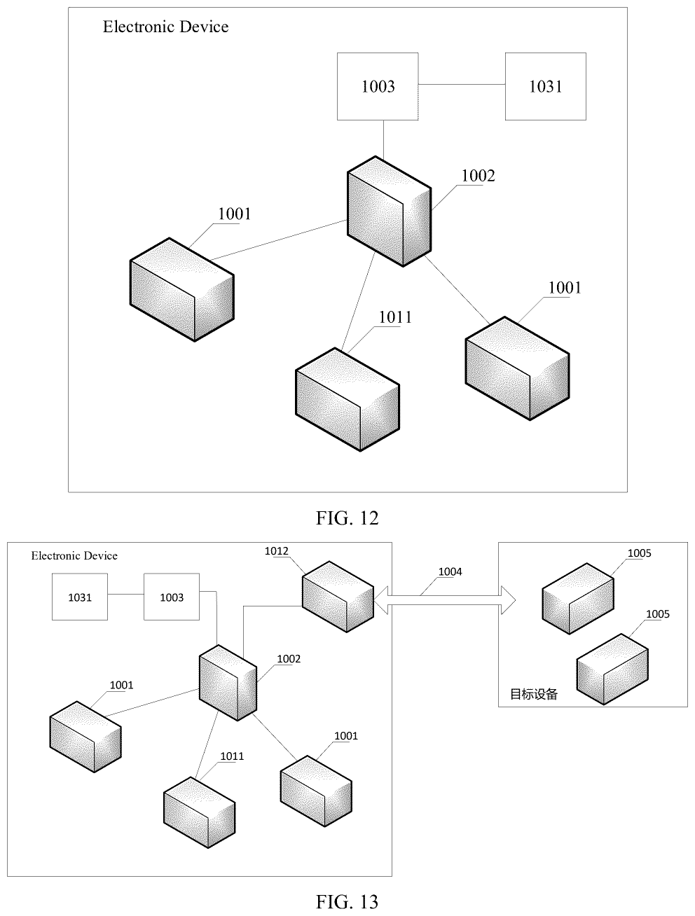

In one embodiment, as shown in FIG. 12, the electronic device may further include an intelligent engine 1003, such as an AI core and/or a large language model (LLM). The intelligent engine 1003 is configured to process user needs obtained through the target application 1031 and utilizes a corresponding capability descriptions to generate a calling request. The intelligent engine 1003 has access to each capability description and is further configured to provide the output results corresponding to the first capability to the target application 1031 as feedback information addressing the user needs.

Based on the above implementation, the target function modules 1001 includes a second function module 1012 arranged on the electronic device. As shown in FIG. 13, the second function module 1012 is configured to establish a connection channel 1004 between the electronic device and a target device. The intelligent engine 1003 is further configured to obtain from the capability management module 1002, the capability description of at least one target capability provided by third function modules 1005 arranged on the target device. The capability description of at least one target capability of the third function modules 1005 is transmitted from the target device to the capability management module 1002 through the connection channel 1004.

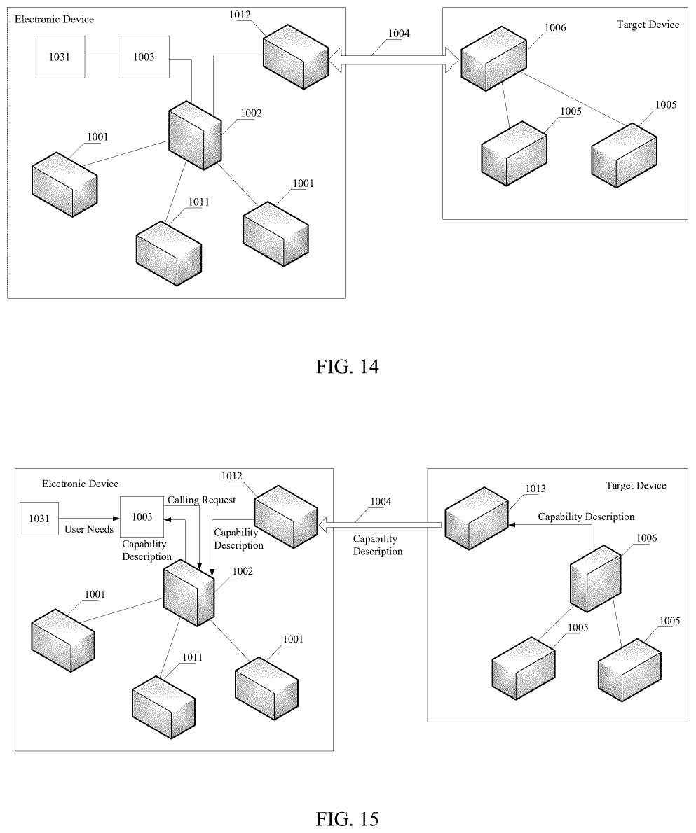

Further, as shown in FIG. 14, the capability management module 1002 is further configured to, when the calling request corresponds to the target device, transmit the calling request to the target device through the connection channel 1004. The target device, through a capability management module 1006, invokes the first service of the first calling service, transmits the input parameters included in the calling request to the third function modules 1005, and obtains the output results corresponding to the first capability from the third function modules 1005 through the second service of the first calling service. The capability management module 1002 is further configured to receive, through the connection channel 1004, the output results corresponding to the first capability as returned by the target device.

For example, as shown in FIG. 15, the capability management module 1002 is arranged on the electronic device, and the capability management module 1006 is arranged on the target device. Smart connect applications 1012 and 1013 are respectively arranged on the electronic device and the target device. A connection channel 1004 is arranged between the smart connect applications 1012 and 1013. The capability management module 1006 is configured to collect a target capability of each third function module 1005 arranged on the target device, as well as the calling service used to invoke the target capability, using the method described above. The capability management module 1006 sends the collected capability descriptions of the target capability to the smart connect application 1013 on the target device. The smart connect application 1013 on the target device transmits the capability descriptions collected by the capability management module 1006 to the smart connect application 1012 on the electronic device through the connection channel 1004. The smart connect application 1012 on the electronic device forwards the capability descriptions collected by the capability management module 1006 to the capability management module 1002. The capability management module 1002 sends both the capability descriptions collected by the capability management module 1002 and the capability descriptions collected by the capability management module 1006 to the intelligent engine 1003. The intelligent engine 1003 can process the user needs and capability descriptions obtained by the voice assistant 1031 to determine the target capability needed to satisfy the user needs, namely the first capability. Based on the determination, the intelligent engine 1003 generates a calling request and provides the calling request to the capability management module 1002. The capability description of the first capability enables the determination of whether the first function module 1011 corresponds to a target function module 1001 arranged on the electronic device or to a third function modules 1005 arranged on the target device.

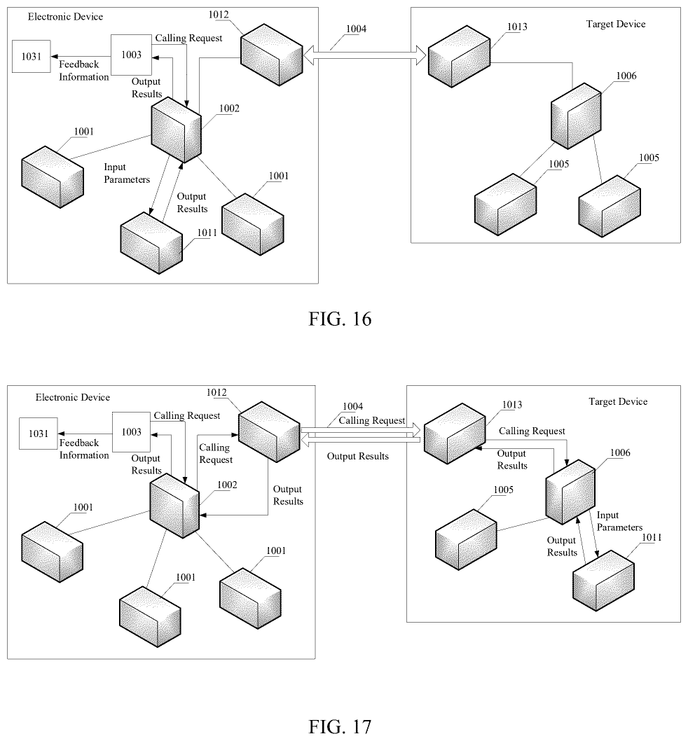

If the first function module 1011 is the target function module 1001 arranged on the electronic device, the capability management module 1002 may determine the first service and the second service of the calling service used to invoke the first capability based on a correspondence relationship on the electronic device. The capability management module 1002 utilizes the first service to transmit the input parameters included in the calling request to a function sub-module corresponding to the first capability within the first function module 1011 on the electronic device. The input parameters are processed by the function sub-module corresponding to the first capability to obtain the output result, thereby implementing the first capability, as illustrated in FIG. 16. The output results obtained are retrieved from the function sub-module corresponding to the first capability in the first function module 1011 through the second service. The capability management module 1002 transmits the output results to the intelligent engine 1003, which provides the output results as feedback information to the voice assistant 1031, which presents the feedback information to a user through voice playback or text output.

If the first function module is a third function module 1005 arranged on the target device, the capability management module 1002 may send the calling request to the smart connect application 1012 on the electronic device. The smart connect application 1012 transmits the calling request to the smart connect application 1013 on the target device through the connection channel 1004, the smart connect application 1013 forwards the calling request to the capability management module 1006. The capability management module 1006 can determine the first service and the second service in the calling service for invoking the first capability based on a correspondence relationship on the target device. The input parameters included in the calling request are transmitted to the function sub-module corresponding to the first capability in the first function module 1011 of the target device through the first service. As shown in FIG. 17, the function sub-module processes the input parameters to obtain an output result, thereby implementing the first capability. The output results are retrieved from the function sub-module through the second service. The capability management module 1006 sends the obtained output results to the smart connect application 1013 on the target device, which transmits the output results to the smart connect application 1012 on the electronic device through the connection channel 1004. The smart connect application 1012 sends the output results to the capability management module 1002. The capability management module 1002 forwards the received output results to the intelligent engine 1003, which uses the output results to generate feedback information addressing the user needs. The intelligent engine 1003 provides feedback information to the voice assistant 1031, which presents the feedback information to a user through voice playback or text output.

Taking the electronic device as a mobile phone as an example, the following illustrates an exemplary technical solution of the present disclosure.

The present disclosure provides a unified method and mechanism that allows system applications and three-party applications within the mobile phone system to declare AI capabilities thereof and required parameters (i.e. input parameters) and return values (i.e. output results) in accordance with the mechanism. Upon system startup, an independent service module, namely the capability management module AS described above, scans all AI capabilities within the system and makes the AI capabilities available to a caller, such as the voice assistant referenced herein. Therefore, when the caller needs to interact with the large language model LLM, the acquired AI capabilities can be utilized to enable the large language model, referred to as the intelligent engine, to determine which capabilities to invoke to fulfill the user needs (i.e., generate the calling request described above). The above data processing method relieves the caller from having to be aware of the capabilities provided within the system or from manually collecting the capabilities to interact with the large language model, thereby significantly enriching scenarios and enhancing an interactive experience for the large language model in executing user instructions.

System applications and third-party applications can declare their AI capabilities by generating XML files, such as the XML file “<?XML version=“1.0” encoding=“utf-8” ?>” and the calling service “ExportCapabilityService” described above. The capability management module AS in the mobile phone system can scan the system to read and parse the declarations of all AI capabilities and provide the parsed capability descriptions to the intelligent engine, such as a large language model or AI Core, thereby expanding the intelligent engine's available capabilities.

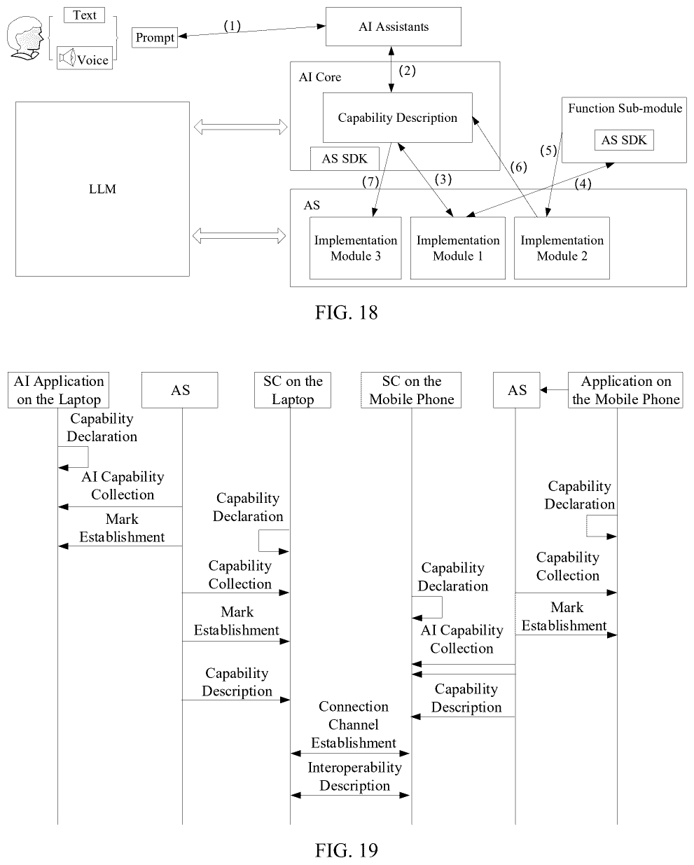

FIG. 18 illustrates an exemplary diagram of an application being applicable to mobile phones to implement capability collection and capability invocation in the present disclosure. The capability management module AS includes a plurality of implementation modules configured to perform exemplary interactions as follows:(1) interaction(s) between user and AI assistant via user interface (UI), for example, a user provides information (such as voice or text) representing user needs as a prompt to the AI assistants; and/or, the AI assistants provide the output results as feedback information to the user via user interface; (2) interaction(s) between the AI assistants and an AI Core, for example, the AI assistants send user needs to the AI Core, and/or the AI Core returns the output results to the AI assistants via UI; (3) interaction(s) between the AI core and implementation module 1, for example, the AI Core processes user needs and process capability descriptions provided by the AS, in combination with an LLM, to generate a calling request, the AI Core transmits the calling request to the implementation module 1 of the AS, and/or implementation module 1 of the AS sends the output results back to the AI Core, the calling request corresponds to a first capability and contains associated input parameters, and the LLM may be arranged locally on the mobile phone or remotely in the cloud; (4) interaction(s) between implementation module 1 and AS software development kit (SDK), for example, the implementation module 1 of the AS transmits the input parameters in the calling request to a function sub-module (e.g., as an action provider) corresponding to the first capability, the transmission occurs through the first service in the calling service that corresponds to the first capability, the function sub-module may be a function sub-module within a target function module arranged on the local mobile phone, or a function sub-module within another function module arranged on a different device interconnected with the mobile phone, such as a tablet device, or the implementation module 1 in the AS receives the output results returned by the function sub-module corresponding to the first capability through a second service in the calling service that corresponds to the first capability; (5) interaction(s) between implementation module 2 and AS software development kit (SDK), for example, the implementation module 2 of the AS scans declaration files of all applications in the mobile phone through a package manager in an operating system to collect the capabilities of all applications (e.g., collect global actions) arranged on a local mobile phone, and the implementation module 2 in the AS receives the capabilities collected by other connected devices through a smart connect application; (6) interaction(s) between the implementation module 2 of AS and AI core, for example, the implementation module 2 of AS synchronizes the capability descriptions of all capabilities to the AI core and/or further to AI assistants; and (7) interaction(s) from AI core to implementation module 3 of AS, for example, the AS can also implement other functions through the implementation module 3. The AI core can invoke some basic abilities of AS if needed, such as screen awareness and natural language understanding (NLU). The capability descriptions of all capabilities include prompt breakdown, functional requirements and arbitration, task understanding and sequencing, and/or function map generation. The AS may scan and invoke the AI capabilities in a system. The AS software development kit (SDK) provides a unified SDK for each application to integrate, enabling the declaration and invocation of the AI capabilities.

FIG. 19 illustrates an interaction sequence diagram for capability collection and capability invocation through smart connect (SC) application (also referred to as SmartConnect application or SC) in a device interconnection scenario. An AI application with AI capabilities such as AI image generation is arranged on a laptop, while an application that requires an AI image generation capability is arranged on a mobile phone. The SC is arranged in both the laptop and the mobile phone. A specific process is as follows.

Each application arranged on the laptop can declare capabilities through a target file, such as an AI mapping capability declared by an AI application, a smart connect capability declared by the SC, and a screen-casting capability. The AS (i.e., agent service) on the laptop can collect the AI capabilities of all applications by parsing the target file and establish tags between AI applications, AI capabilities and calling services. The AS on the laptop sends the capability descriptions of the AI capabilities received from the mobile phone to the SC on the laptop.

In addition, the AS on the laptop can also provide the capability descriptions of all available capabilities to the laptop's AI Core. The AI Core, in conjunction with the LLM, can process user needs and the capability descriptions from the AS to generate a corresponding calling request.

Similarly, each application arranged on the mobile phone declares capabilities, such as a smart connect capability declared by the SC. the AS on the mobile phone can collect the capabilities of all applications and establish tags between the applications, corresponding capabilities and calling services. The AS on the mobile phone sends the capability descriptions of the collected capabilities to the SC on the mobile phone.

In addition, the AS on the mobile phone can also provide the capability descriptions of all capabilities to the AI Core of the mobile phone. The AI Core can utilize the LLM to process user needs in combination with the capability descriptions provided by the AS, thereby generating a calling request.

Based on the above, the SC on the mobile phone and the SC on the laptop exchange the capability descriptions of the capabilities collected through an established connection channel. Specifically, the SC on the mobile phone provides the capability descriptions transmitted from the SC on the laptop to the AS on the mobile phone, which forwards the capability descriptions to the AI Core on the mobile phone. Similarly, the SC on the laptop provides the capability descriptions received from the SC on the mobile phone to the AS on the laptop, which forwards the capability descriptions to the AI Core on the laptop.

Therefore, the AS in any device participating in an interconnection stores the capability descriptions of all capabilities across the interconnected devices. Similarly, the AI Core in each device participating in an interconnection also stores the capability descriptions of all capabilities from all interconnected devices.

Specifically, the SC of a laptop can manage the capability descriptions obtained from the AS through a SmartConnect capability manager (MGR) and save the capability descriptions in a capability list. Likewise, the SC on the mobile phone can use a MGR to manage the capability descriptions received from its AS and store the capability descriptions in a capability list. Moreover, the laptop and the mobile phone can establish a private connection channel through respective SCs, allowing the laptop and the mobile phone to exchange capability descriptions stored in respective MGR capability lists over the channel.

Alternatively, the target file of the SC on the laptop may also include a target file sent by the SC on the mobile phone, which declares the capabilities of the mobile phone. By parsing the target file, the AS on the laptop can directly obtain the capability descriptions of each application on the mobile phone. The AS on the laptop then provides the capability descriptions to the AI Core on the laptop. Similarly, the target file of the SC on the mobile phone may also include the target file sent by the SC on the laptop, which declares the capabilities of the laptop (such as AI capabilities). By parsing the target file sent by the SC on the laptop, the AS on the mobile phone can directly obtain the capability descriptions of each application on the laptop (such as AI applications). The AS on the mobile phone provides the capability descriptions to the AI Core on the mobile phone.

Therefore, after the capability descriptions of the respective SCs on the laptop and the mobile phone are exchanged, the capability list of the MGR of the SC on the laptop includes not only the capability descriptions of the capabilities on the laptop but also the capability descriptions of the capabilities of each application on the mobile phone. Correspondingly, the AS of the laptop includes not only the capability descriptions on the laptop but also the capability descriptions of each application on the mobile phone. In addition to the capability descriptions of the capabilities of the SC on the mobile phone, the MGR capability list on the mobile phone also includes the capability descriptions of each application on the laptop, such as the AI mapping capability. Correspondingly, the AS on the mobile phone includes not only the capability descriptions of the SC on the mobile phone but also capability descriptions of each application on the laptop, such as the AI mapping capability.

In addition, the respective SCs of the laptop and the mobile phone can update other local applications in real time with the capabilities of applications from another device. For example, if the AI image generation capability on the laptop changes, the SC on the mobile phone can obtain updated capabilities through a connection channel and transmit the updated capabilities to the AS on the mobile phone.

It should be noted that after capability interoperability, other applications on the mobile phone can use the AS to query both the smart connect capabilities declared by the SC and the AI capabilities of the laptop received by SC, such as the AI mapping capability.

Based on the above solution, the mobile phone can receive input data such as text or voice that represents the user needs through the voice assistant. The input data indicates a need to use an AI mapping capability. The AI Core on the mobile phone processes the input data along with the capability descriptions of all available capabilities to generate a calling request corresponding to the AI image generation capability. The AI Core sends the calling request to the SC on the mobile phone. The SC on the phone forwards the calling request through the connection channel to the SC on the laptop. The SC on the laptop invokes the AI mapping capability of the AI application on the laptop by a corresponding calling service. For example, the input parameters in the calling request are passed to the AI application through the first service. After the AI application generates an image, the resulting image, i.e., the output results are retrieved through a second service and returned to the SC on the laptop. The SC on the laptop transmits the output results to the SC on the mobile phone through a connection channel. Upon receiving the output, the SC on the mobile phone forwards the output results to the voice assistant on the mobile phone, thereby realizing the AI image generation capability of the laptop through the voice assistant on the mobile phone.

Each embodiment in the present specification is described progressively, with each focusing on distinctions thereof from other embodiments. Common or similar components across various embodiments may be cross-referenced. Regarding the devices disclosed in the embodiments, since the devices correspond to the methods described above, the descriptions of the devices are relatively concise. For relevant details, references may be made to the method-related sections.

Professionals may further realize that units and algorithm steps of each example described in conjunction with the embodiments disclosed herein can be implemented with electronic hardware, computer software, or a combination thereof. To clearly illustrate the interchangeability between hardware and software, the components and steps of each embodiment have been generally described above in terms of functional roles thereof. Whether the functions are implemented in hardware or software depends on a specific application and design constraints of the technical solution. A person skilled in the art may implement the described functionality using different methods for different applications. However, the implementations should not be considered beyond the scope of the present disclosure.

Steps of the data processing methods or algorithms described in conjunction with the embodiments disclosed herein may be implemented directly in hardware, through software modules executed by a processor, or by a combination of hardware and the software modules. The software modules may reside in random access memory (RAM), read-only memory (ROM), electrically programmable ROM (EPROM), electrically erasable programmable ROM (EEPROM), registers, hard disks, removable disks, CD-ROMs, or any other form of storage medium known in the art.

As disclosed, the data processing method and the electronic device provided by the present disclosure at least realize the following beneficial effects.

The unified data processing method and mechanism enables system applications and third-party applications within a mobile phone system to declare respective AI capabilities of the applications, along with required parameters (i.e., input parameters) and return values (i.e., output results), in accordance with the disclosed mechanism. Upon system startup, an independent service module, namely, the capability management module AS described above, scans all AI capabilities within the mobile phone and makes the AI capabilities available to a caller, such as the voice assistant referenced herein. Accordingly, when the caller requires interaction with a large language model (LLM), the acquired AI capabilities can be utilized to enable the LLM, also referred to as the intelligent engine, to determine which capabilities to invoke to fulfill the user needs (i.e., to generate the calling request described above). The data processing method provided by the present disclosure eliminates a need for the caller to be aware of the AI capabilities provided by the system or to manually collect such capabilities for interaction with the LLM, thereby significantly enriching the interaction scenarios and enhancing the user experience during execution of user instructions by the LLM.

In various embodiments, all modules and/or models, such as capability management module, intelligent engine, AI core, and/or LLM, included in the electronic device may be running on one or more processors of the electronic device. Each module/model may be executed by corresponding processor(s) capable of performing the module's function. One or more modules/models may be executed by same processor(s) or different processor(s), of the electronic device. In various embodiments, modules and/or models may include hardware or a combination of hardware and software.

The above description of the disclosed embodiments enables a person skilled in the art to implement or utilize the present disclosure. Various modifications to the embodiments will be readily apparent to a person skilled in the art, and generic principles defined herein may be applied in other embodiments without departing from the spirit or scope of the present disclosure. Therefore, the present disclosure is not limited to the embodiments shown herein but is to be accorded with the broadest scope consistent with principles and novel features disclosed herein.

What is claimed is:

1. A data processing method, comprising:
obtaining target files belonging to target function modules; and
parsing the target files to obtain at least one target capability possessed by the target function modules and a calling service that invokes the at least one target capability, wherein:
each target capability includes a capability name and a capability description, and the capability description is expressed in natural language, and
the calling service of each target capability includes a first service that provides input parameters for processing by a target function module of the target function modules and a second service that obtains output results from the target function module.

2. The method according to claim 1, further comprising:
establishing a tag for the target function module, the tag representing a correspondence relationship among the target function module, each target capability of the target function module, and the calling service that invokes each target capability.

3. The method according to claim 2, further comprising:
obtaining a calling request used to invoke a first capability, the calling request including input parameters; and
sending, based on the correspondence relationship, the input parameters in the calling request to a first function module through the first service of a first calling service, and obtaining output results corresponding to the first capability from the first function module through the second service of the first calling service.

4. The method according to claim 3, wherein:
the calling request is a request generated based on processing user needs obtained through a target application and each capability description; and
output results corresponding to the first capability are configured to be provided to the target application as feedback information addressing the user needs.

5. The method according to claim 4, further comprising:
processing, based on an intelligent engine including each capability description, the user needs obtained through the target application and each capability description, to generate the calling request; and
providing, based on the intelligent engine, the output results corresponding to the first capability are provided to the target application as feedback information addressing the user needs.

6. The method according to claim 1, wherein a target file belonging to each target function module is scanned through a package manager in an operating system.

7. An electronic device, comprising: one or more processors and a memory containing computer program that, when being executed, causes the one or more processors to perform:
obtaining target files belonging to target function modules; and
parsing the target files to obtain at least one target capability possessed by the target function modules and a calling service that invokes the at least one target capability, wherein:
each target capability includes a capability name and a capability description, and the capability description is expressed in natural language, and
the calling service of each target capability includes a first service that provides input parameters for processing by a target function module of the target function modules and a second service that obtains output results from the target function module.

8. The electronic device according to claim 7, wherein the one or more processors are further configured to perform:
establishing a tag for the target function module, the tag representing a correspondence relationship among the target function module, each target capability of the target function module, and the calling service that invokes each target capability.

9. The electronic device according to claim 8, wherein the one or more processors are further configured to perform:
obtaining a calling request used to invoke a first capability, the calling request including input parameters; and
sending, based on the correspondence relationship, the input parameters in the calling request to a first function module through the first service of a first calling service, and obtaining output results corresponding to the first capability from the first function module through the second service of the first calling service.

10. The electronic device according to claim 9, wherein:
the calling request is a request generated based on processing user needs obtained through a target application and each capability description; and
output results corresponding to the first capability are configured to be provided to the target application as feedback information addressing the user needs.

11. The electronic device according to claim 10, wherein the one or more processors are further configured to perform:
processing, based on an intelligent engine including each capability description, the user needs obtained through the target application and each capability description, to generate the calling request; and
providing, based on the intelligent engine, the output results corresponding to the first capability are provided to the target application as feedback information addressing the user needs.

12. The electronic device according to claim 7, wherein a target file belonging to each target function module is scanned through a package manager in an operating system.

13. An electronic device, comprising:
one or more processors; and
a capability management module running on a corresponding processor of the one or more processors, configured to cause the corresponding processor to obtain target files, which belong to at least one target function module, and parse the target files to obtain at least one target capability of the at least one target function module and a calling service that invokes the at least one target capability, wherein:
each target capability includes a capability name and a capability description, and the capability description is expressed in natural language, and
the calling service of each target capability includes a first service that provides input parameters for processing by a target function module of the at least one target function module and a second service that obtains output results from the target function module.

14. The electronic device according to claim 13, wherein the capability management module is further configured to cause the corresponding processor to:
obtain a calling request for invoking a first capability, the calling request including input parameters,
transmit, based on a correspondence relationship stored in the capability management module, the input parameters in the calling request to a first function module through a first service of a first calling service, and obtain output results corresponding to the first capability from the first function module through a second service of the first calling service; and
establish a tag for the target function module, the tag representing a correspondence relationship among the target function module, the target capability of the target function module, and the calling service of the target capability.

15. The electronic device according to claim 14, further comprising an intelligent engine running on a corresponding processor of the one or more processors, wherein:
the intelligent engine is configured to process user needs obtained through a target application and each capability description to generate the calling request;
the intelligent engine includes each capability description; and
the intelligent engine is further configured to provide the output results corresponding to the first capability as feedback information to the target application addressing the user needs.

16. The electronic device according to claim 15, wherein the capability management module is further configured to cause the corresponding processor to transmit a collected capability description of each target capability to the intelligent engine.

17. The electronic device according to claim 15, wherein the intelligent engine further includes an artificial intelligence core configured to understand natural language intent.

18. The electronic device according to claim 17, wherein the intelligent engine further includes a large language model (LLM).

19. The electronic device according to claim 15, wherein:
the target function module includes a second function module arranged on the electronic device, the second function module establishes a connection channel between the electronic device and a target device;
the intelligent engine is further configured to cause the corresponding processor to obtain, from the capability management module, a capability description of at least one target capability of third function modules arranged on the target device; and
the capability description of the at least one target capability of the third function modules is sent from the target device to the capability management module through the connection channel.

20. The electronic device according to claim 16, wherein the capability management module is further configured to cause the corresponding processor to:
send the calling request to the target device through the connection channel when the calling request corresponds to the target device, wherein the target device invokes the first service of the first calling service through the capability management module, sends the input parameters in the calling request to the third function modules, and obtains output results corresponding to the first capability from the third function modules through the second service of the first calling service; and
receive the output results corresponding to the first capability sent by the target device through the connection channel.
